(19) United States
(12) Patent Application Publication
(10) Pub. No.: US 2015/0079288 A1
(43) Pub. Date: Mar. 19, 2015

(54) PLUG ASSEMBLY FOR MASKING THREADED HOLES

(71) Applicant: Caterpillar Inc., Peoria, IL (US)

(72) Inventor: Daniel J. Sordelet, Peoria, IL (US)

(73) Assignee: Caterpillar Inc., Peoria, IL (US)

(21) Appl. No.: 14/552,506

(22) Filed: Nov. 25, 2014

(51) Int. Cl. B05C 21/00

(52) U.S. Cl. CPC B05C 21/005
USPC 427/287; 118/505

(57) ABSTRACT

A plug assembly for masking internal threads of a base component is disclosed herein. The plug assembly includes a plug member having peripheral margin portions. The peripheral margin portion is engagable with the internal threads of the base component. The plug consists of a water-soluble material and is structured and arranged to dissolve in a water based liquid.

### TECHNICAL FIELD

The present disclosure relates generally to manufacturing of a metallic component. More specifically, the present disclosure relates to a plug assembly for masking the threaded holes while manufacturing the metallic component.

### BACKGROUND

Engines commonly include various metallic components, such as engine blocks, which undergo wear and tear during prolonged and continuous operations. These metallic components are required to be manufactured for reuse. “Manufacturing” herein refers to reforming of the metallic component to correct dimensions by coating the metallic component with the same or the different material as that of the metallic component. Various manufacturing processes, such as a thermal spray process, may be used to manufacture a metallic component. In the thermal spray process, the metallic component is coated with a coating material to correct the dimensions of the metallic component. Further, the metallic component commonly includes threaded holes that require protection from the coating material during the thermal spray process. Therefore, a plug assembly may be required to protect the threaded hole during the thermal spray process.

Conventionally, a cylindrical mask plug made of rubber material were used to mask the threaded hole. The mask plug would be inserted in the threaded hole before coating the metallic component. The mask plug of completely cylindrical shape may be insufficient to mask the threaded hole, and some coating material may still flow through the threaded hole. This results result in poor quality of the threaded hole after completion of manufacturing of the metallic component. Moreover, once the thermal spray process is completed, the mask plug needs to be removed from the metallic component using various machining processes known in the art. These machining processes may be laborious and cumbersome to perform and are also likely to damage the threaded hole during operation. This results in poor quality of threaded hole after completion of the manufacturing process.

U.S. Pat. No. 7,147,899 discloses a method of masking cooling holes of a gas turbine component. The method includes applying mask material to the cooling holes, thickening the mask material, coating the gas turbine component, and removing the remaining mask material from the cooling hole. Although this reference provides the method of masking the cylindrical cooling hole of the gas turbine component with a mask material and removing the remaining mask material by use of various machining processes, no solution is provided for masking the threaded hole of the metallic component that can be removed without use of such machining processes.

### SUMMARY OF THE INVENTION

One aspect of the present disclosure is directed to plug assembly for masking internal threads of a base component. The plug assembly including a plug member having peripheral margin portions engagable with the internal threads of the base component. The plug member consists of a water-soluble material and is structured and arranged to dissolve in a water based liquid.

Another aspect of the present disclosure is directed to a method of manufacturing a metallic component. The metallic component having at least one threaded hole. The at least one threaded hole having internal threads. The method includes masking the at least one threaded hole using a plug member. The plug member consisting of a water soluble material. Masking the at least one threaded holes includes inserting the plug member in the at least one threaded hole, coating the external surface, and de-masking the at least one threaded hole. Insertion of the plug member in the at least one threaded hole of the metallic component facilitates covering of the internal threads of the at least one threaded hole. Thereafter, the external surface of the metallic component is coated with a coating material. After coating the at least one threaded hole is de-masked by causing the plug member to dissolve by exposing the plug member to a water-based liquid.

### BRIEF DESCRIPTION OF THE DRAWINGS

FIG. 1 is a top view of a portion of an engine having at least one threaded hole, in accordance with the concepts of the present disclosure;

FIG. 2 is a cross-sectional view of a plug assembly that protects internal threads within the at least one threaded hole of a metallic component of FIG. 1, in accordance with the concepts of the present disclosure;

FIG. 3a is a cross-sectional view of an assembly of the metallic component and a first embodiment of the plug assembly, describing insertion of the plug assembly in the at least one threaded hole;

FIG. 3b is a cross-sectional view of the assembly of the metallic component and a second embodiment of the plug assembly, describing insertion of the plug assembly in the at least one threaded hole;

FIG. 4 is a cross-sectional view of the assembly of the metallic component and the plug assembly, describing coating of the metallic component by thermal spray process;

FIG. 5 is a cross-sectional view of the assembly of the metallic component and the plug assembly, describing de-masking of the at least one threaded hole, in accordance with the concepts of the present disclosure;

FIG. 6 is cross-sectional view of a portion of the metallic component after completion of the manufacturing process; and

FIG. 7 is a flow chart that depicts an exemplary method of manufacturing the metallic component by use of the thermal spraying process.

### DETAILED DESCRIPTION

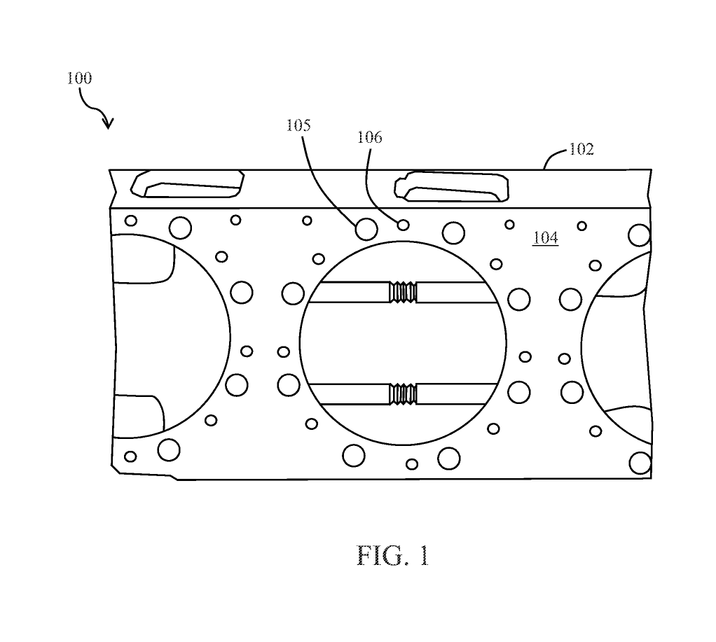

Referring to FIG. 1, there is shown a portion of an engine 100 having a base component. The base component of the engine 100 may be a metallic component 102 that needs to be manufactured to its correct dimensions. The engine 100 may embody a petrol engine, a diesel engine, a dual-fuel engine, and/or such similar engines. Although, the concepts of the present disclosure are directed towards the metallic component 102 of the engine 100, it may be contemplated that the concepts of the disclosure may be applied to the metallic components of various other machines such as a generator, a turbine, and/or such similar machines. Concepts of the present disclosure may also be employed to applications that include non-metallic components.

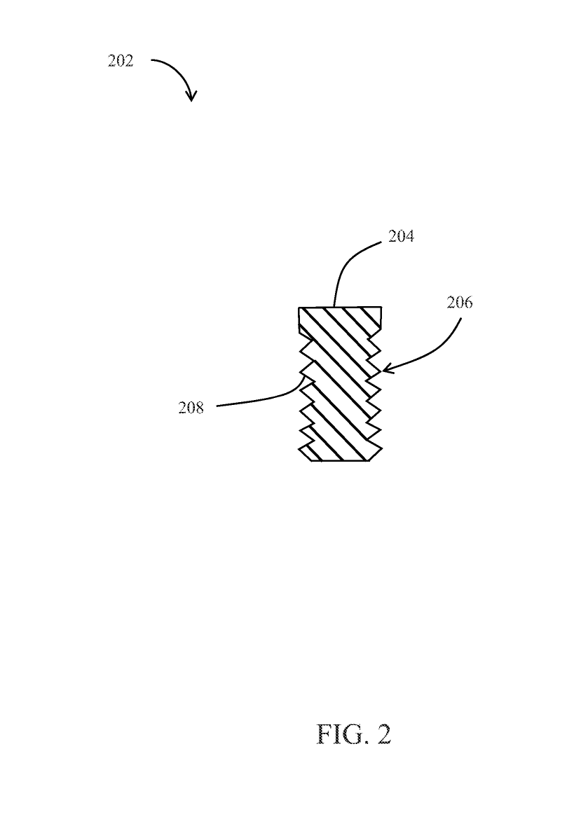

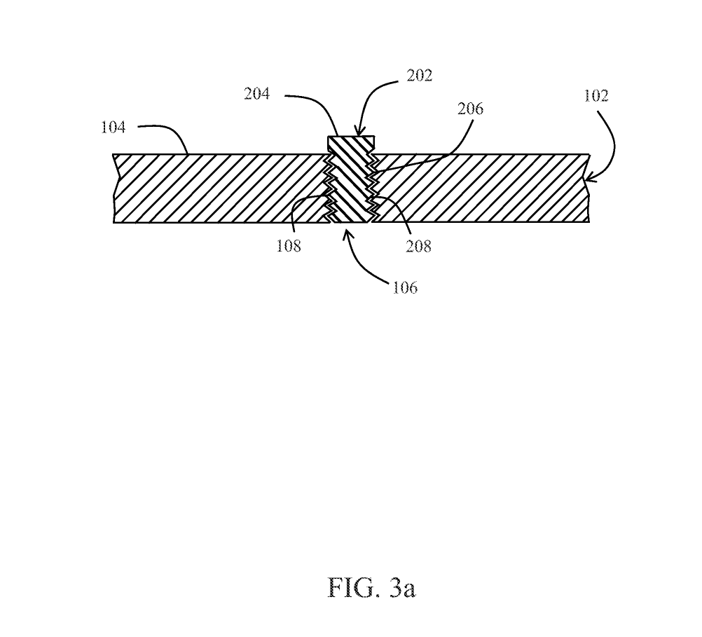

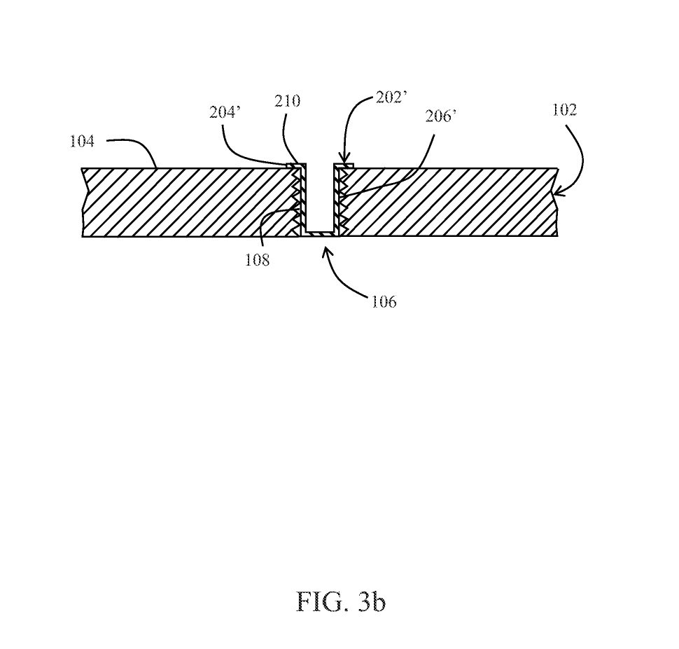

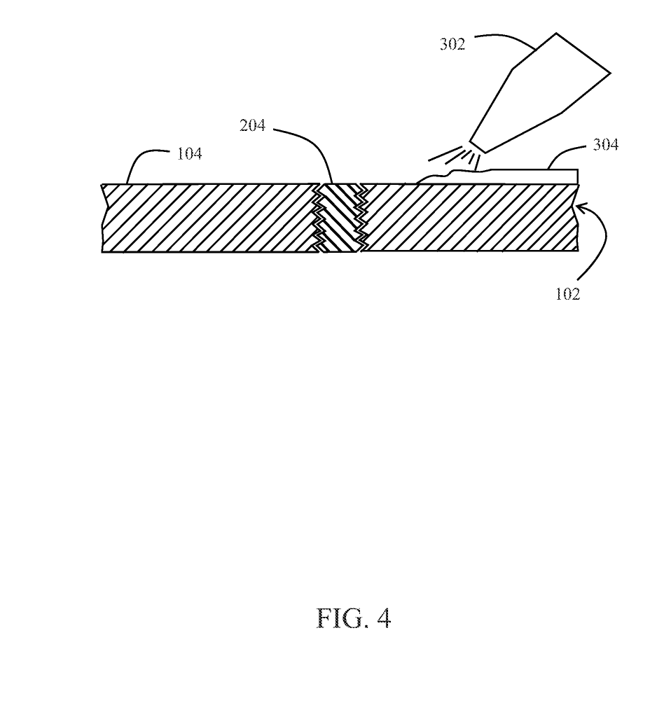

In the current embodiment of the disclosure, the metallic component 102 is an engine block, that includes an external surface 104, holes 105 and at least one threaded hole 106 in the metallic component 102. As is customarily known, the threaded hole 106 of the metallic component 102 includes internal threads 108 (as shown in FIGS. 3-6) that facilitate mounting of various other components of the engine 100 to the metallic component 102. Furthermore, the metallic component 102 may occasionally require to be manufactured. In a manufacturing process, the dimensions of the metallic component 102 may be corrected so that it can be used for different process requirements. The manufacturing process of metallic components 102, may involve operations such as, boring, honing, grinding, micro-polishing, resurfacing, surface coating, re-aligning, etc. In the current embodiment of manufacturing process, a thermal spray process is performed to add the external surface 104 over the metallic component 102 with a coating material 304 (as shown in FIGS. 4-6). It may be noted that during the manufacturing process, the threaded hole 106 needs to be masked. Masking of the metallic component 102 includes inserting a plug assembly 202 (as shown in FIG. 2) in to the threaded hole 106, coating the external surface 104 of the metallic component 102, and then de-masking the plug assembly 202 (as shown in FIG. 2) to obtain a manufactured metallic component 102.

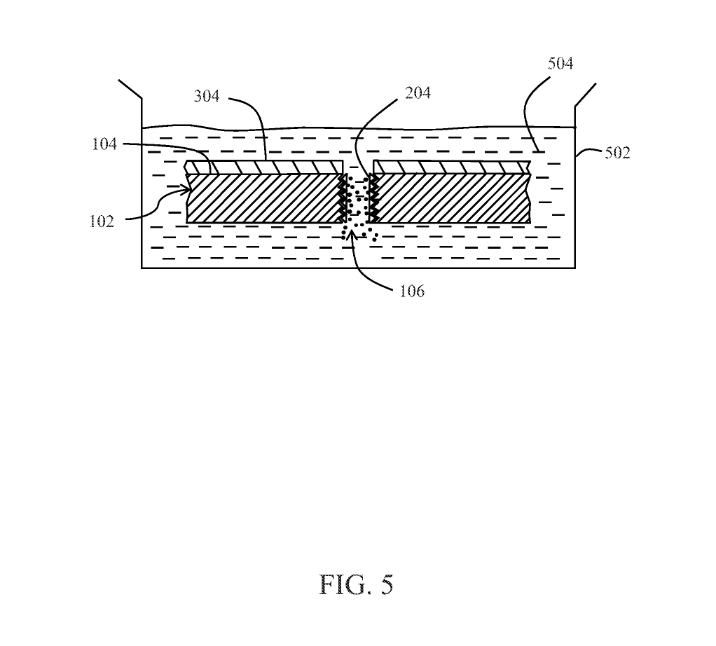

Referring to FIG. 2, there is shown the plug assembly 202 that masks the threaded hole 106, during manufacturing process. The plug assembly 202 includes a plug member 204 made up of a water-soluble material and is structured and arranged to dissolve in a water based liquid 504 (as shown in FIG. 5). It may be envisioned that the plug member 204 may be made of any water-soluble material, such as but not limited to, Monopol C100, ISOBAM, cellulose, and/or similar polymer compounds. The plug member 204 may be a cylindrical member having peripheral margin portions 206 engagable with internal threads 108 of the metallic component 102. In a first embodiment, the peripheral margin portions 206 of the plug member 204 includes external threads 208 that are made conjugate to the internal threads 108 of the threaded hole 106, as best seen in FIG. 3a. The external threads 208 may be manufactured by any of the known thread-cutting techniques known in the art, such as but not limited to, the thread milling method, taps and dies method, and the like.

Referring to FIG. 3a-6, there is shown the step-wise illustration of masking process of the metallic component 102. It may be envisioned that before initiating the masking process, the external surface 104 and the internal threads 108 of the metallic component 102 may be cleansed by any of the known methods, such as but not limited to, grinding, shaping, oil treating.

Referring to FIG. 3a, there is shown an assembly of the metallic component 102 and the first embodiment of the plug assembly 202, describing insertion of the plug member 204. The masking process initiates with insertion of the plug member 204 in to the threaded hole 106 of the metallic component 102 to protect the internal threads 108. Preferably, the plug member 204 may be inserted in to the threaded hole 106 by screwing or fastening the plug member 204 to the threaded hole 106. When the plug member 204 is fastened with the threaded hole 106, the external threads 208 of the plug member 204 meshes with the internal threads 108 of the threaded hole 106. This facilitates an air tight sealing of the threaded hole 106. Moreover, during assembly of the plug member 204 with the metallic component 102, there may be a possibility of a certain portion of the plug member 204 that protrudes outside the external surface 104. The portion of plug member 204 that protrudes outside of the external surface 104 may be machined flush to the external surface 104 by various known techniques in the art, such as, but not limited to, milling, shaping, planning, and other similar techniques.

Referring to FIG. 3b, there is shown an assembly of the metallic component 102 and a second embodiment of the plug assembly 202′, describing insertion of the second embodiment of the plug assembly 202′. The plug assembly 202′ in the second embodiment includes a cup-shaped plug member 204′. The plug member 204′ defines a peripheral margin portions 206′ and a flange portion 210. The plug member 204′ is inserted in to the threaded hole 106 so that the peripheral margin portions 206′ makes a tight fit with the internal threads 108 of the metallic component 102. In that position, the flange portion 210 of the plug member 204′ may rest on the external surface 104 of the metallic component 102. Subsequently, the flange portion 210 may be machined flush to the external surface 104 to obtain a planar external surface 104. It may be noted that the forthcoming FIGS. may describe further steps of masking process in accordance with the first embodiment of the plug assembly 202, however use of second embodiment of the plug assembly 202′ may also be envisioned.

Referring to FIG. 4, there is shown the assembly of the metallic component 102 and the first embodiment of the plug member 204, describing coating of the metallic component 102 using thermal spray process. In the thermal spray process, a thermal spray torch 302 is used to spray hot molten coating material 304 on top of the external surface 104 of the metallic component 102. The thermal spray torch 302 may work on the principle of plasma spraying, detonation spraying, wire arc spraying, and/or similar operating principles. The molten coating material 304 forms a uniform coating and adheres to the external surface 104 when cooled. It may be contemplated that the coating material 304 may be of same material as that of the metallic component 102 and/or an alloy of the material of the metallic component 102.

Referring to FIG. 5, there is shown the assembly of the metallic component 102 and the plug member 204 being dipped in a hot-water bath 502, describing de-masking of the metallic component 102. After coating, a core of the plug member 204 may be drilled out and the assembly of the metallic component 102 and the plug member 204 may be introduced to a hot-water bath 502 to perform de-masking. The hot-water bath 502 may contain the water based liquid 504, such as hot-water maintained at a pre-determined range of temperature. As the plug member 204 is made of water soluble material, the plug member 204 may dissolve in the water based liquid 504, when introduced to the hot-water bath 502. However, the present disclosure contemplates drilling of the core of the plug member 204 before being introduced to the hot-water bath 502, it may be envisioned that drilling the core of the plug member 204 does not limit the scope of the present disclosure.

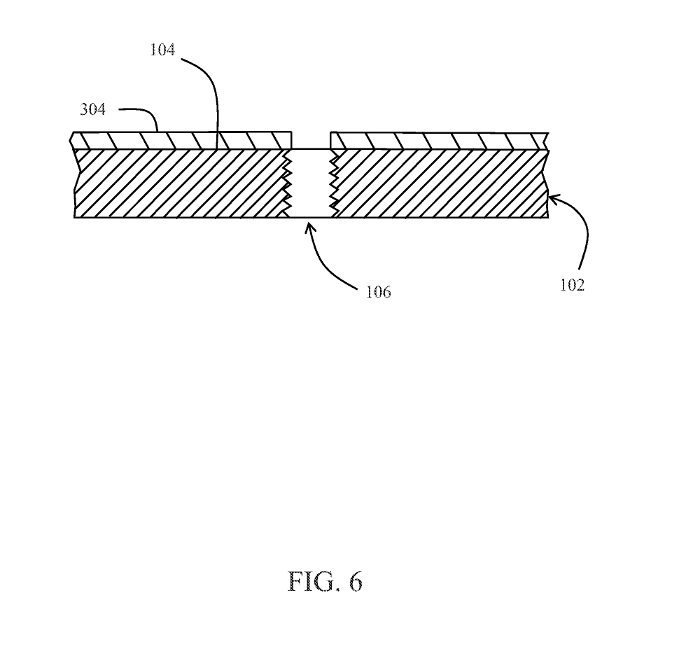

Referring to FIG. 6, there is shown the cross-sectional view of the metallic component 102 after completion of the masking process. In the final state, the coating material 304 is coated on the external surface 104 of the metallic component 102 and without any damage to the threaded hole 106. Thereafter, the metallic component 102 may be installed and used in the engine 100 (FIG. 1) after performing certain finishing operations, such as but not limited to, grinding, filing, shaving, polishing, and the like.

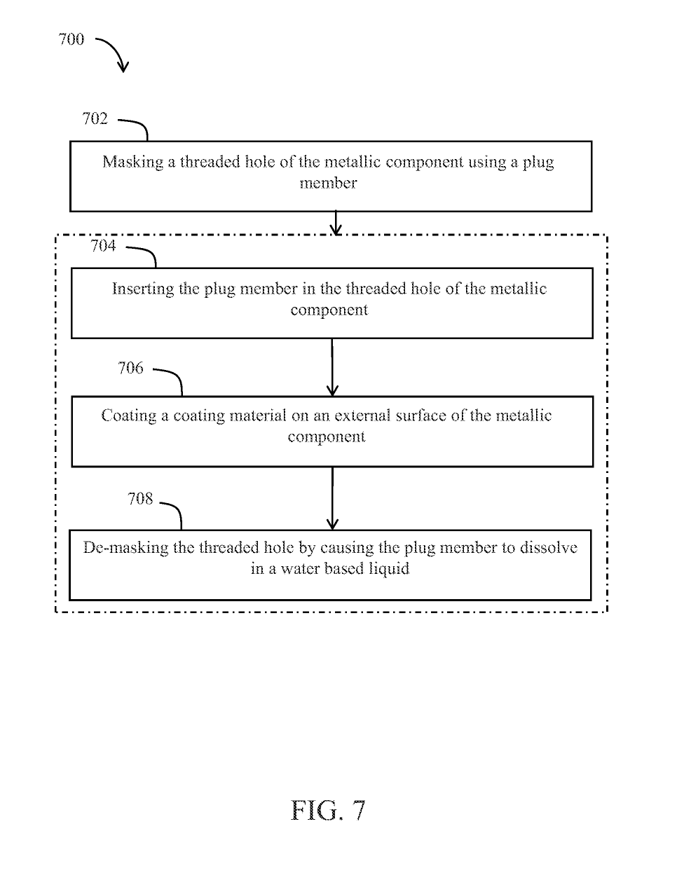

Referring to FIG. 7, there is shown a flow chart that depicts the method 700 of the manufacturing process that has been performed on the metallic component 102. The method 700 initiates at step 702.

At step 702, the threaded hole 106 of the metallic component 102 is masked. Masking of the metallic component 102 refers to protection of the threaded hole 106. Masking includes insertion of the plug member 204 in the threaded hole 106, coating the external surface 104, and de-masking the threaded hole 106. It may be noted that various steps of masking process may be explained in the forthcoming steps of the method 700.

At step 704, the plug member 204 is inserted in to the threaded hole 106 of the metallic component 102. The plug member 204 may be inserted by screwing the plug member 204 with the threaded hole 106. The screwing of the plug member 204 with the threaded hole 106 facilitates sealing of the threaded hole 106. Thereafter, the method 700 proceeds to step 706.

At step 706, the coating material 304 is sprayed on the external surface 104 of the metallic component 102 to coat the external surface 104. This enables the coating of the external surface 104. Once the coating is performed on the external surface 104, the method 700 proceeds to step 708.

At step 708, the plug member 204 is de-masked from the metallic component 102. The assembly of the metallic component 102 and the plug member 204, after being coated, is introduced to the hot-water bath 502, thereby causing the plug member 204 to be removed from the metallic component 102.

Industrial Applicability

In operation, the metallic component 102 of the engine 100 may require to be manufactured. While manufacturing the metallic component 102, the threaded hole 106 may require to be masked. Moreover, during masking of the threaded hole 106, the metallic component 102 broadly undergoes insertion, coating, and de-masking. Initially, the plug member 204, 204′ of the plug assembly 202, 202′ is inserted in to the threaded hole 106 of the metallic component 102. This facilitates engaging the threaded hole 106 with the plug member 204, 204′.

Once the threaded hole 106 is inserted, the metallic component 102 is exposed to the coating process. In the coating process, the thermal spray torch 302 sprays hot molten coating material 304 on the external surface 104 of the metallic component 102. Since, the plug member 204, 204′ is already inserted in in the threaded hole 106, there is no flow of coating material 304 in to the threaded hole 106 during the coating process. This facilitates coating of the external surface 104, while protecting the threaded hole 106 from the coating material 304. After the coating process, the metallic component 102 is cooled and then undergoes the de-masking process.

In the de-masking process, the assembly of the metallic component 102 fitted with the plug member 204, 204′ is submersed in a hot-water bath 502. The plug member 204, 204′ being made of water-soluble material, dissolves in the hot-water bath 502. Therefore, the plug member 204, 204′ is removed from the threaded hole 106 when introduced to the hot-water bath 502. As the plug member 204, 204′ is removed by feeding in to the hot-water bath 502, it avoids any additional labor and effort associated with removing thermal coating from threads of the threaded hole 106 which is cumbersome and time consuming Also, the removal of the plug member 204, 204′ by dissolving the same in the hot-water bath 502 better protects the internal threads 108 of the threaded hole 106 which may be otherwise damaged or unclean if the thermal coating was allowed to attach to and diminish the integrity of the threads of the threaded hole 106 of the metallic component 102.

It should be understood that the above description is intended for illustrative purposes only and is not intended to limit the scope of the present disclosure in any way. Those skilled in the art will appreciate that other aspects of the disclosure may be obtained from a study of the drawings, the disclosure, and the appended claim.

What is claimed is:

1. A plug assembly for masking internal threads of a base component, the plug assembly comprising:
a plug member having peripheral margin portions engagable with the internal threads of the base component, the plug member consisting of a water-soluble material, wherein the plug member being structured and arranged to dissolve in a water based liquid.

2. A method of manufacturing a metallic component, the metallic component having an external surface and at least one threaded hole therein, the at least one threaded hole having internal threads, the method comprising:
masking the at least one threaded hole using a plug member, the plug member consisting of a water soluble material, wherein masking includes:
inserting the plug member in the at least one threaded hole of the metallic component, thereby covering the internal threads of the at least one threaded hole;
coating the external surface of the metallic component with a coating material; and
de-masking the at least one threaded hole, wherein de-masking includes:
causing the plug member to dissolve by exposing the plug member to a water based liquid.
